(19) United States
(12) Patent Application Publication
(10) Pub. No.: US 2009/0116212 A1
(43) Pub. Date: May 7, 2009

(54) Indicator Having an Electrooptical Display

(76) Inventors: Peter Dietrich, Gross-Zimmern (DE); Ulrich Kabatek, Babenhausen (DE)

Correspondence Address: COHEN, PONTANI, LIEBERMAN & PAVANE LLP, 551 FIFTH AVENUE, SUITE 1210, NEW YORK, NY, 10176, US

(21) Appl. No.: 11/991,703

(22) PCT Filed: Aug. 28, 2006
(86) PCT No.: PCT/EP2006/065716

§ 371 Date: Mar. 7, 2008

(30) Foreign Application Priority Data
Sep. 9, 2005 (DE) 10 2005 043 235.2

(51) Int. Cl. G01D 11/28

(52) U.S. Cl. 362/23

(57) ABSTRACT

In the case of an indicator having an electrooptical display (1), a shutter (2) is arranged in front of the display (1), partially covers the display (1) and has an area which covers the display (1) such that the covered area of the display (1) illuminates the shutter (2), by parts (2a, 2b, 2d, 2f, 2g) of the shutter (2) being designed to be translucent

The invention relates to an indicator having an electrooptical display. Electrooptical displays, for example liquid-crystal displays, organic light-emitting diode displays (OLED) or electron tubes are known from the prior art. Liquid-crystal displays, in particular when they are in the form of TFT displays, and electron tubes have a nearly rectangular shape. Special shapes cannot be produced or only at great cost. If such electrooptical displays are to be combined with other indicators, for example analog pointer instruments, as is known, for example, from combination instruments in motor vehicles, it is possible for the design of the electrooptical displays to only be relatively small and there remains space which is not useful.

It is an object of the invention to specify an indicator having an electrooptical display which can be used particularly effectively. This object is achieved by virtue of the fact that a faceplate is arranged in front of the display, which faceplate partially covers the display, with the faceplate thus having a region covering the display and the display having a covered region, and that the covered region of the display illuminates the faceplate and that parts of the faceplate are translucent. It is also possible to realize indicators having electrooptical displays in this way, in which the visual perception in an observer does not appear to be rectangular. It is furthermore possible in the faceplate, for example, for signs such as warning notices or scales of an indicator to be simulated, which are illuminated by the display, also with different brightness.

If the display is a color display, the signs on the faceplate can be illuminated with different colors and thus appear in different colors. It is furthermore possible to change the colors of the illumination as a function of the information which is to be displayed.

The design of the indicator is particularly simple if the covered region of the display illuminates the covered part of the faceplate. Here, the faceplate can be mounted directly on the display, which results in a flat simple structure. If an optical waveguide is arranged between the display and the faceplate, the light of the display can also be guided into a region of the faceplate that does not cover the display. In this way, additional luminous means are saved. If the faceplate is in the form of a switch, additional illumination of the switch can be dispensed with on the one hand, and on the other hand the current switched state of the switch can be presented by a change in illumination for example in terms of color and/or brightness.

If the faceplate has moving parts, additional information can also be presented, for example. This is the case particularly if the moving part is in the form of an pointer element. Here, the pointer can be backlit directly by in each case those parts of the display illuminating the pointer which are covered by the pointer. In the case of a color display, it is also possible for presenting any additional information or depending on the position of the pointer to change the color and/or brightness of the illumination. This pointer element can be designed particularly easily as a ring pointer, which creates a good impression. It is also possible here for the ring pointer to be illuminated via the display, for example by direct light injection or by a rotating light-guiding ring into which light is injected for example also via the display.

A pane pointer is also possible, in which a pointer is arranged on an otherwise clear pane and said pane is arranged in front of the display, in particular such that it can rotate about its center.

If the display is in the form of an LCD it consumes little power. In particular if it is in the form of a TFT-LCD it can also be used as a color display. If the display is in the form of an electron tube its indicator can be presented particularly clearly.

The invention will be explained in more detail below using the figures, in which:

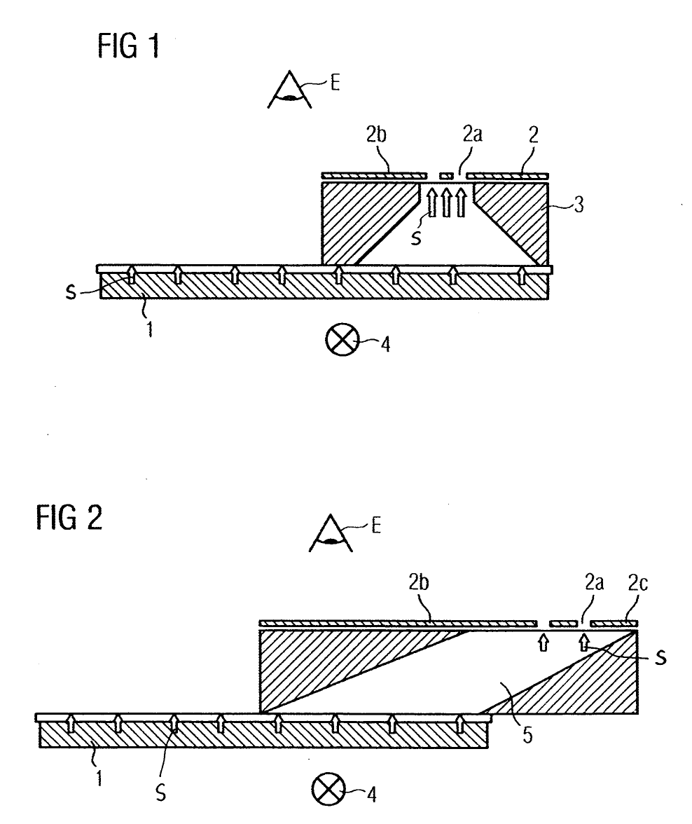

FIG. 1 shows a section of a first exemplary embodiment of the invention,

FIG. 2 shows a section through a second exemplary embodiment of the invention,

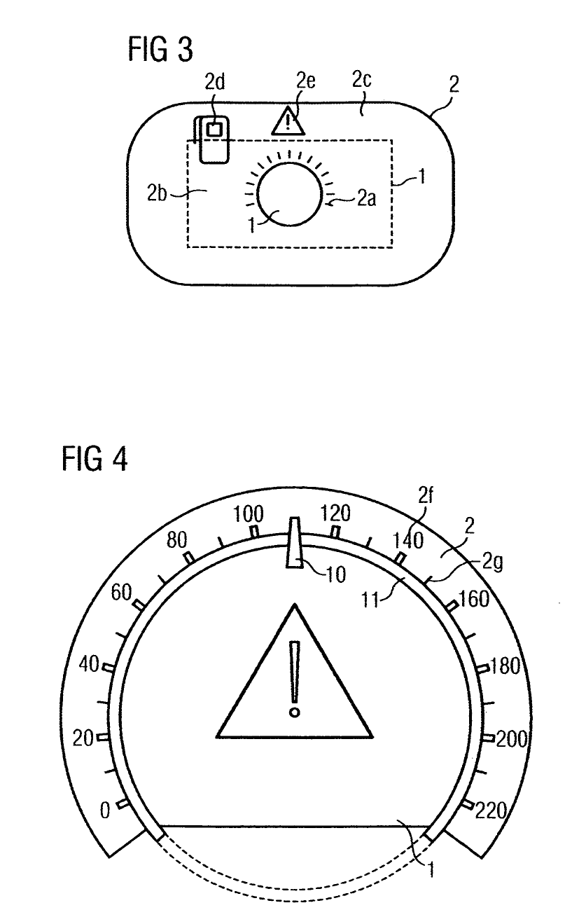

FIG. 3 shows a plane view of a third exemplary embodiment of the invention,

FIG. 4 shows a plane view of a fourth exemplary embodiment of the invention,

FIG. 5 shows the partially mechanical structure of the exemplary embodiment from FIG. 4, and

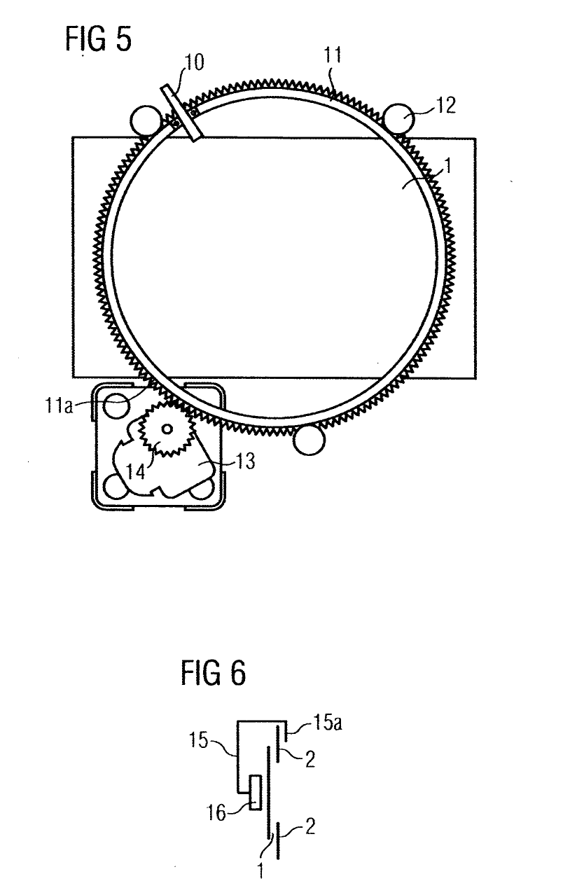

FIG. 6 shows a further exemplary embodiment.

FIG. 1 shows a display 1, a faceplate 2, with light passages 2a, a light guide in the form of a light box 3, an illuminating apparatus 4 and, illustrated symbolically, an eye E of an observer and light beams S. The display 1 is, for example, a liquid-crystal display in the form of a TFT display, with which color presentation is possible. Said display is illuminated by an illuminating apparatus 4. Parts of the light beams S penetrating the display 1 do not directly reach the eye E of the observer, but are guided to the light passages 2a of the faceplate 2 via the light box 3. It is also possible in this manner for information in the form of, for example, scale marks or numerical values to be presented through the light passages 2a. Said information can be presented in different colors if the display emits corresponding light beams. If the display 1 has organic light-emitting diodes (OLED) rather than an LCD as the display, the illuminating apparatus 4 is unnecessary.

In FIG. 2, the design of the faceplate 2 is such that the faceplate 2 not only has regions 2b which cover the display. The exemplary embodiment in FIG. 2 differs from the exemplary embodiment in FIG. 1 in that the faceplate 2 has a region 2c behind which there is no display 1, as viewed by an observer with the eye E. Furthermore, the light guide is in the form of an optical waveguide 5, for example composed of glass or a light-guiding plastic such as polyacryl. The optical waveguide 5 also guides the light beams in the region 2c of the faceplate 2 behind which there is no display. It is thus possible to also illuminate any regions of the faceplate which are laterally remote from the display. For example, the shape of the indicator can be selected freely, although the display 1 is rectangular.

The display 1 and the faceplate 2 can be seen in plane view onto the indicator according to FIG. 3. The faceplate 2 has a region 2b which is arranged above the display and a region 2c behind which there is no display. Furthermore, the faceplate 2 has light passages in the form of scale marks 2a, a fuel symbol 2d and a general warning symbol 2e. The abovementioned light passages 2a, 2d and 2e are illuminated via optical waveguides (not illustrated) by the display 1. A pointer associated with the scale marks 2a can be presented, for example, on the display 1.

A display 1, a faceplate 2, a ring pointer 10 and a partially covered ring 11 can be seen in the indicator in FIG. 4. scale values 2f and scale marks 2g can be seen on the faceplate 2. Advantageously a negative presentation (bright or white scale values and scale marks on dark or black background) is selected rather than (as illustrated) a positive presentation (black scale values and scale marks on white background) with the result that the scale marks and scale values can be in the form of light passages in the faceplate. These light passages can be in the form of openings in the faceplate, for example, or can be implemented by translucent regions. The positive presentation in FIG. 4 was chosen merely because it was easier to illustrate. The ring 11 can, for example, emit light itself (as illustrated) or be composed of translucent material which is opaque or light-reduced in the direction of the observer and injects the light present in it in the ring pointer 10 with the result that the ring pointer 10 is illuminated. Light can be injected into the ring 11 by way of the display 1 or a separate light source. It is likewise possible to arrange an additional optical waveguide besides the ring 11 and to inject light directly into the ring pointer 10.

In the partially illustrated mechanical structure in FIG. 5, the display 1 and the ring 11 can be seen. Furthermore, bearings 12 of the ring and a drive 13 with toothed wheel 14 are illustrated. The toothed wheel 14 engages in teeth of a toothed rim 11a which is integral with the ring 11. It is also possible to use other friction-fitting or force-fitting gear mechanism combinations instead of a toothed wheel, such as V belt or toothed belt. Light is injected from the display 1 into the ring 11 and, from there, injected into the ring pointer 10, thus illuminating the ring pointer 10. The ring 11 itself is covered or coated with an opaque layer in the direction of the observer.

It is also possible to use, instead of a ring pointer, a pointer 15 which is cranked a number of times and whose drive 16 is arranged behind the display 1, and which is guided outwards behind the display to beyond the boundaries of the display, then is bent again, bent twice, in the direction of its axis of rotation and can represent a pointer needle 15a which can move over the display 1 and the faceplate 2 without the need to guide a drive shaft through the display 1 (FIG. 6).

1.-14. (canceled)

15. An indicator, comprising:
an electrooptical display configured to emit light beams from a front surface; and
a faceplate arranged in front of said electrooptical display and partially covering said front surface of said display such that said faceplate has a first region covering a covered region of said display, said covered region of said display illuminates said faceplate, and said faceplate having translucent portions.

16. The indicator of claim 15, wherein the light beams emitted from said covered region of said display illuminate said first region of said faceplate.

17. The indicator of claim 15, further comprising an optical waveguide arranged between said display and said faceplate.

18. The indicator of claim 17, wherein said faceplate comprises a second region which does not cover said front of said display, said optical waveguide guiding light from said display into said second region of said faceplate.

19. The indicator of claim 15, wherein said faceplate is a counter.

20. The indicator of claim 15, wherein said faceplate has a stationary part and a moving part.

21. The indicator of claim 20, wherein said moving part is a pointer element.

22. The indicator of claim 20, wherein said moving part is illuminated by a portion of said display covered by said moving part.

23. The indicator of claim 21, wherein said pointer element is a ring pointer.

24. The indicator of claim 23, wherein said ring pointer is illuminated by said display.

25. The indicator of claim 15, wherein said display is a liquid crystal display.

26. The indicator of claim 15, wherein said display is a thin film transistor liquid crystal display.

27. The indicator of claim 15, wherein said display is an organic light-emitting display.

28. The indicator of claim 15, wherein said display is an electron tube display.
